(19) United States
(12) Patent Application Publication
(10) Pub. No.: US 2005/0281264 A1
(43) Pub. Date: Dec. 22, 2005

(54) Method for transferring data via multicast and the system thereof

(76) Inventors: Shun-Lung Hsu, Tao Yuan City (TW); Ho-Kuei Fu, Tao Yuan Shien (TW)

Correspondence Address: RABIN & BERDO, P.C., Suite 500, 1101 14th Street, N.W., Washington, DC, 20005, US

(21) Appl. No.: 11/033,825

(22) Filed: Jan. 13, 2005

(30) Foreign Application Priority Data
Jun. 21, 2004 (TW) 93117996

(51) Int. Cl. H04L 12/28; H04L 12/56

(52) U.S. Cl. 370/390; 370/432

(57) ABSTRACT

The present invention relates to a data transferring method for a multicast system. The multicast system includes a server, a switch and clients. First, the server creates a multicast group and broadcasts the data blocks of a data series sequentially and repeatedly. When clients would like to download the data series from the server in different instances, they join the same multicast group and receive the data blocks from the data block that the server is currently broadcasting. At the same time, the clients also generate a receiving history regarding the data block first received. The clients can determine when to stop receiving the data blocks based on the receiving history.

### RELATED APPLICATIONS

The present application is based on, and claims priority from, Taiwan Application Serial Number 93117996, filed Jun. 21, 2004, the disclosure of which is hereby incorporated by reference herein in its entirety.

### BACKGROUND

1. Field of Invention

The present invention relates to a data transferring method. More particularly, the present invention relates to a data transferring method for a multicast system.

2. Description of Related Art

When the multicast system is employed for transferring data between a server and clients, clients who want to request the same data from the server will first join a multicast group. The requested data will be cast by the server and forwarded by a switch to this multicast group. Therefore, all clients who join this multicast group can receive the same data from the server.

However, a criterion for this type of data transferring method is that all clients have to join this multicast group at the same time. If subsequent clients would like to request the same data from the server, they cannot join this multicast group. Another multicast group will be created, and the subsequent clients have to join the new multicast group. The server will cast another copy of the same data to the new multicast group.

FIG. 1 is a diagram illustrating a data transferring method for a multicast system in the prior art. When the clients 16A, 16B and 16C request the data from the server 12 at the first instance, the server 12 will create a multicast group I. Clients 16A, 16B, and 16C all join the multicast group I. The server 12 then broadcasts the data block set 18A. The data block set 18A is forwarded by the switch 14 to the clients 16A, 16B, and 16C who join the multicast group I.

Later, when the clients 16D, 16E, and 16F request the same data from the server 12 at the second instance, the server 12 will create a new multicast group II. Clients 16D, 16E, and 16F join the new multicast group II instead of the original multicast group I. The data block set 18B of the same data will be broadcasted by the server 12 and forwarded by the switch 14 to the clients 16D, 16E, and 16F who join the multicast group II.

However, the data block set 18A and 18B are actually identical since all clients 16A to 16F request the same data from the server 12. The server 12 has to broadcast two identical data block sets 18A and 18B merely because different clients request the same data at different instances. This generates an enormous loading on the server 12. If each client requests the same data from the server 12 at different instances, the server 12 has to create a corresponding multicast group for each client. The server 12 will be quickly overwhelmed by casting identical data block sets repeatedly.

For the foregoing reasons, there is a need for an improved data transferring method for the multicast system such that when clients request the data at different instances, the server does not have to broadcast the same data repeatedly and the server will not be overwhelmed easily.

### SUMMARY

It is therefore an objective of the present invention to provide a data transferring method for a multicast system. When different clients request the same data from the server at different instances, they can join the same multicast group.

It is another objective of the present invention to provide a multicast system.

In accordance with the foregoing and other objectives of the present invention, a data transferring method for a multicast system is proposed. The multicast system includes a server, a switch supporting a multicast group, and clients. First, the server creates a multicast group and casts the data blocks of a data series sequentially and repeatedly. Next, when one of the clients wants to receive the data series at one instance, it joins the multicast group for receiving the data blocks forwarded from the switch. The client receives the data blocks from the one that the server is currently casting, and generates a receiving history regarding the data block first received. Finally, the client determines when to stop receiving the data blocks based on the receiving history.

According to another objective of the present invention, a multicast system is proposed. The multicast system includes a server, a switch, and clients. The server creates a multicast group and casts the data blocks of a data series sequentially and repeatedly. The switch forwards the data blocks from the server to the clients who join the multicast group. When one of the clients would like to receive the data series from the server, it joins the multicast group. The client receives the data blocks from the one that the server is currently casting, and generates a receiving history regarding the data block first received. The client then determines when to stop receiving the data blocks based on the receiving history.

According to the data transferring method of the present invention, when different clients request the same data from the server at different instances, the server doesn't have to create a corresponding multicast group for each client. All clients can join the same multicast group. By generating a receiving history regarding the data block first received, all clients can know when to stop receiving the data blocks and complete the data transfer. The data transferring method according to the present invention can dramatically reduce the loading on the server. The transferring efficiency increases as the number of the clients increases. The construction and maintenance cost of the network and the server can also be reduced.

It is to be understood that both the foregoing general description and the following detailed description are by examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a diagram illustrating the data transferring method for the multicast system in the prior art

FIG. 2 is a flowchart illustrating the data transferring method according to the present invention;

FIGS. 3A and 3B are diagrams illustrating one preferred embodiment according to the present invention;

FIG. 4 is a diagram illustrating the application of the data transferring method according to the present invention on a computer assembly line; and

FIGS. 5A and 5B are block diagrams illustrating the multicast system according to the present invention.

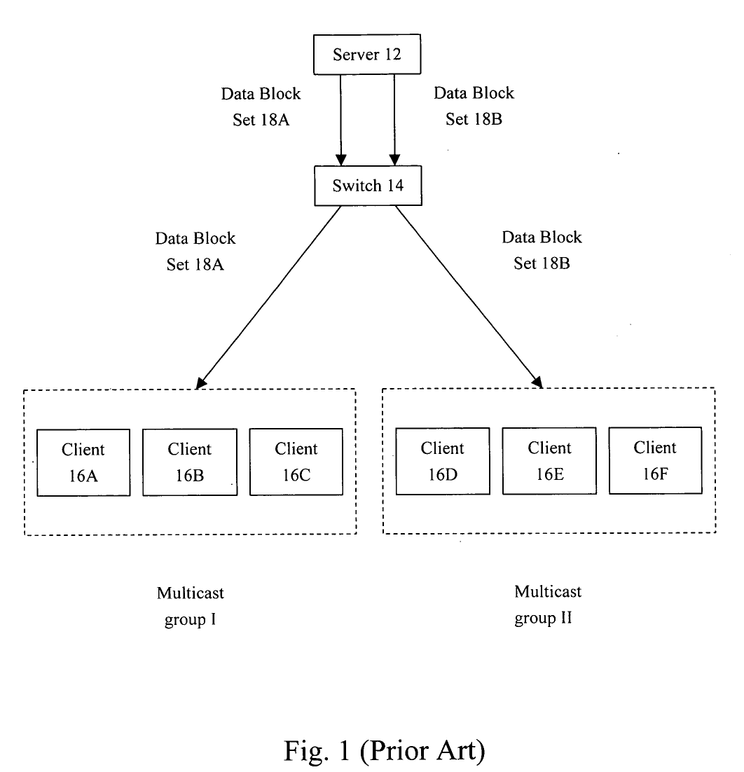

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

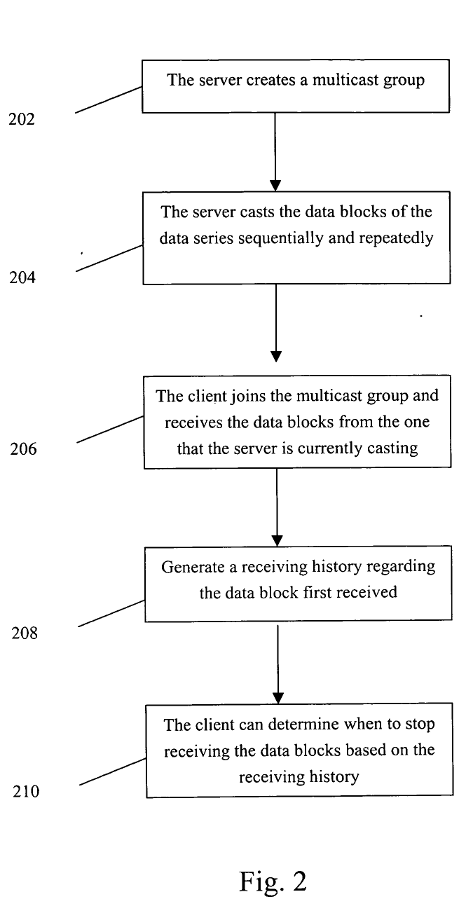

FIG. 2 is a flowchart illustrating the data transferring method for a multicast system according to the present invention. The multicast system includes a server, a switch supporting the multicast group, and clients. When clients would like to receive the data series from the server, they join the multicast group for receiving the data series forwarded from the switch.

The data transferring method for a multimedia system according to the present invention is that the server first creates a multicast group (step 202). Next, the server casts the data blocks of the data series sequentially and repeatedly (step 204).

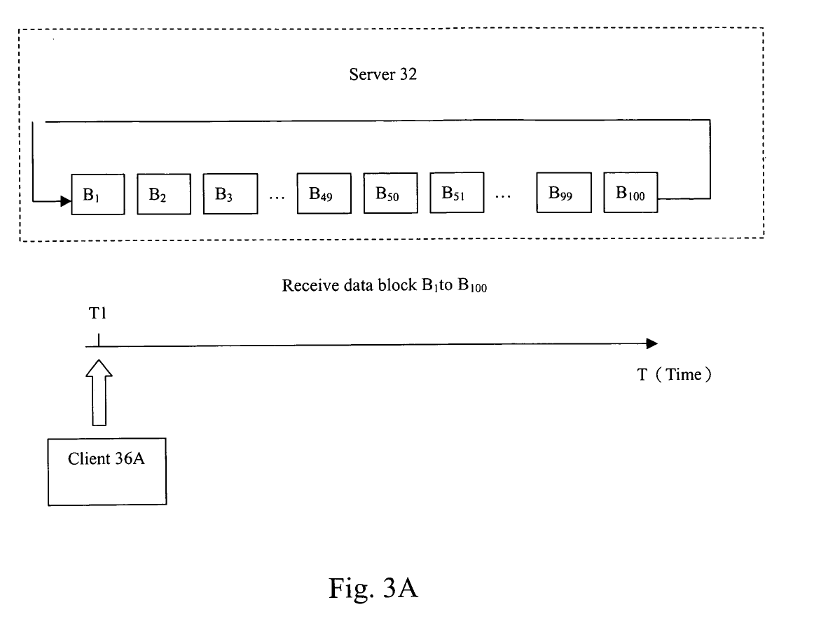

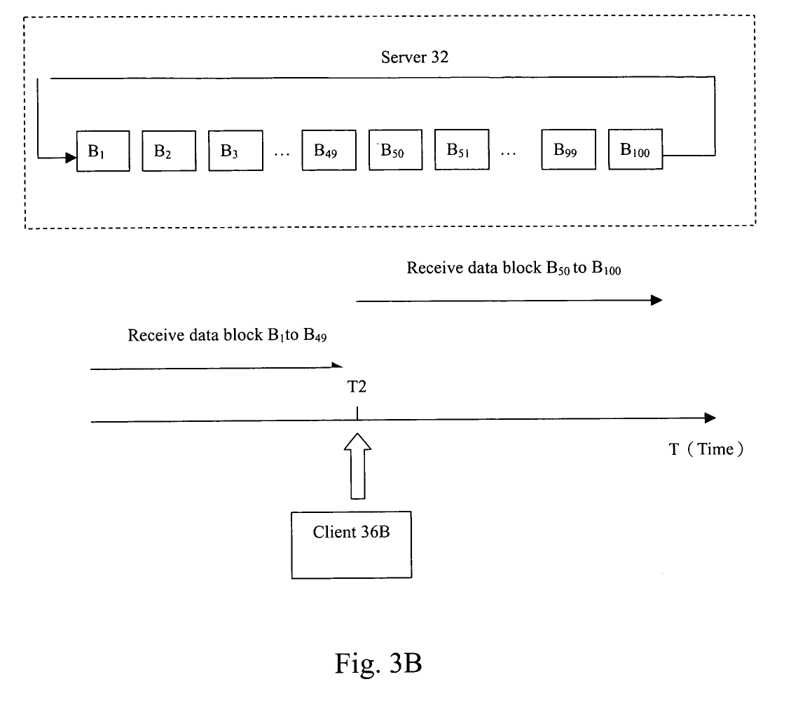

When one client would like to receive the data series at the instance T1 (shown in the FIG. 3A), it joins the multicast group and receives the data blocks from the one that the server is currently casting (step 206). Since the server broadcasts the data blocks of the data series sequentially and repeatedly, by generating a receiving history regarding the data block first received (step 208), the client can determine when to stop receiving the data blocks based on the receiving history and complete the data transfer (step 210).

FIGS. 3A and 3B are diagrams further illustrating one preferred embodiment according to the data transferring method of the present invention. The server 32 broadcasts the data blocks B₁ [symbol] B₂ [symbol] B₃ . . . B₄₉ [symbol] B₅₀ [symbol] B₅₁ . . . B₉₉ [symbol] B₁₀₀ of a data series sequentially and repeatedly. In the FIG. 3A, when the client 36A requests receiving the data series from the server 32 at first instance T1, it joins the multicast group. The switch can recognize the joining of the clients to the multicast group by IGMP (Internet Group Management Protocol). When the client 36A joins the multicast group, the server 32 is casting the data block B1. Therefore, the client 36A can download the complete data series from the server 32 by receiving the data blocks B₁ to B₁₀₀ sequentially.

In the FIG. 3B, if a subsequent client 36B requests the same data series from the server 32 at the instance T2, it joins the same multicast group as the client 36A joins. At the time the client 36B joins the multicast group, the server is broadcasting the data block B₅₀. Therefore, the client 36B would receive the data blocks from the data block B₅₀. Since the server 32 casts the data blocks of the data series sequentially and repeatedly, the clients 36B can keep receiving the data block B₁ after receiving the data block B₁₀₀. Furthermore, the client 36B generates a receiving history regarding the data block first received, the data block B₅₀. Therefore, based on the receiving history, the client 36B stops the downloading after receiving the data block B₄₉ and the complete data series can be downloaded to the client 36B.

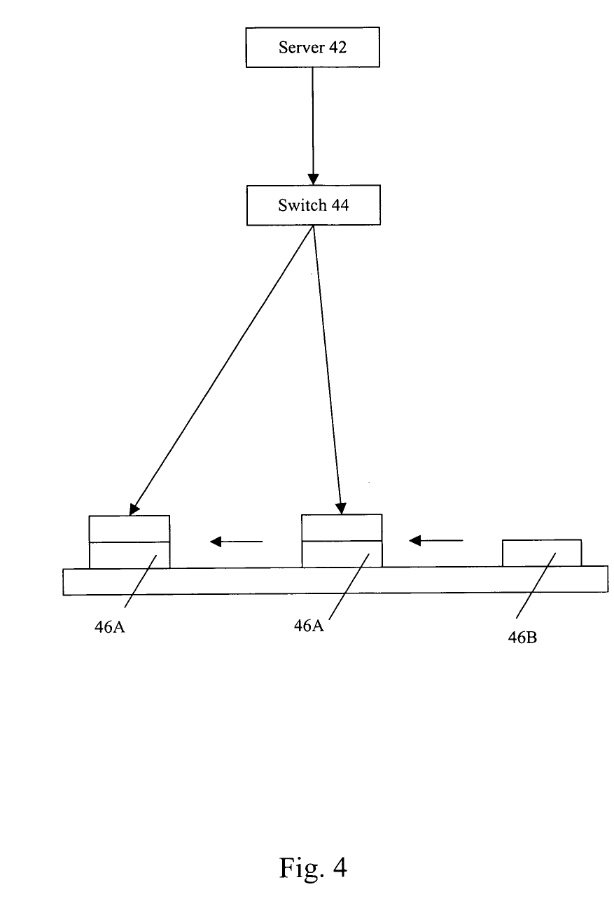

The data transferring method according to the present invention is particularly suitable for the software installation in a computer assembly line. FIG. 4 is a diagram illustrating the application of data transferring method according to the present invention in a computer assembly line. As shown in the FIG. 4, there is an assembled computer 46A prior to the installation of the software and unassembled computer 46B. The assembled computer 46A needs the installation of the software, such as the operating system and other application software.

When the installation is started, the assembled computer 46A first connects to the switch 44 and joins the multicast group created by the server 42. The computer 46A then downloads the software to be installed from the server 42. Later, when the unassembled computer 46B is assembled, it also connects to the switch 44 and joins the same multicast group. The computer 46B receives the data blocks of the software to be installed from the one that the server 42 is currently casting. The computer 46B also generates a receiving history so it can determine when to stop receiving the data blocks. Therefore, no matter when the computer is assembled, it can join the same multicast group and download the software to be installed.

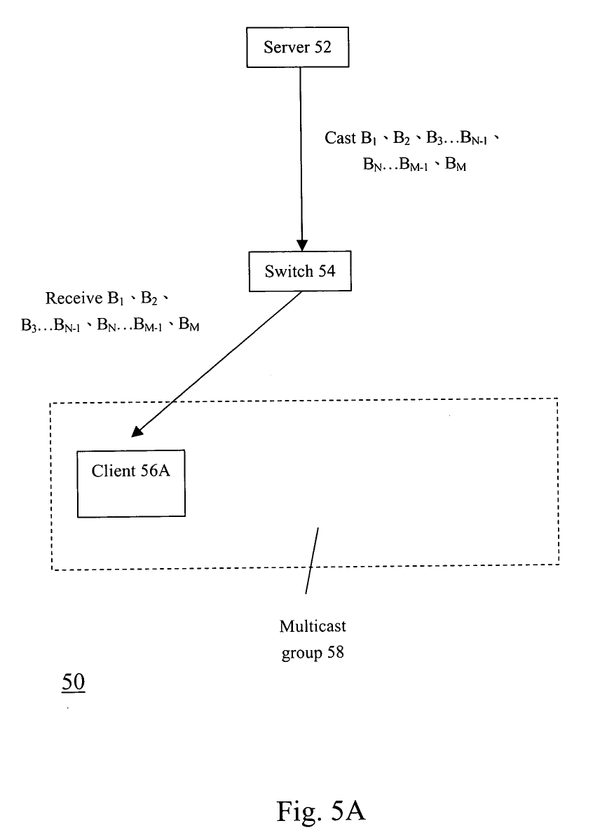

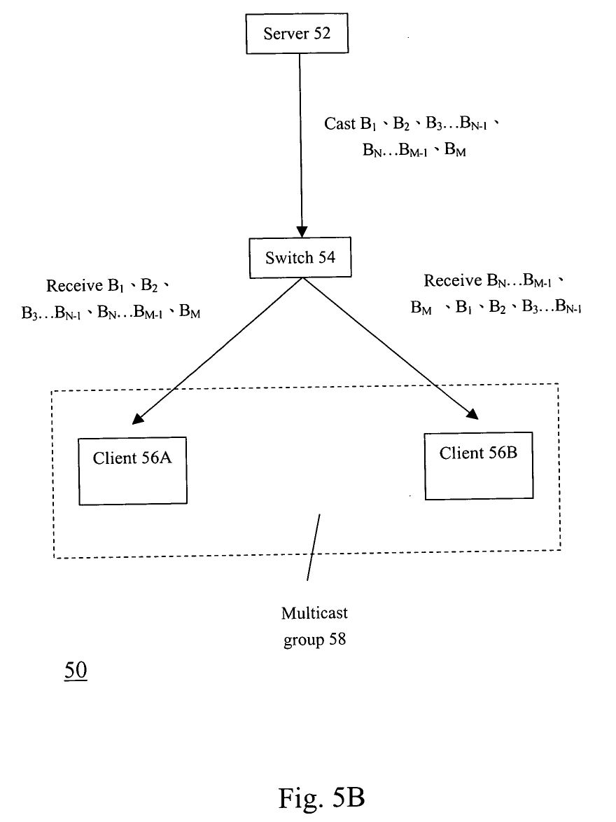

FIGS. 5A and 5B are block diagrams illustrating the multicast system according to the present invention. The multicast system 50 includes a server 52, a switch 54, clients 56A and 56B. The server 52 broadcasts data blocks B₁ [symbol] B₂ [symbol] B₃ . . . B_{N-1} [symbol] B_{N} . . . B_{M-1} [symbol] B_{M} of a data series sequentially and repeatedly, wherein N and M are positive integers and N is smaller than M. The switch 54 forwards the data blocks to a multicast group 58. The switch 54 can recognize the joining of the clients to the multicast group 58 by IGMP. FIG. 5A shows that when the client 56A would like to download the data series from the server 52 at the first instance, it joins the multicast group 58 and receives the data blocks from B₁ to B_{M} forwarded from the switch 54.

FIG. 5B shows that when the client 56B requests downloading the same data series from the server 52 at the second instance, it also joins the multicast group 58. At this time, the server 52 is casting the data block B_{N}. Therefore, the client 56B receives the data blocks of the data series from the data block B_{N}. Since the server 52 casts the data blocks of the data series sequentially and repeatedly, the client 56B can keep receiving the data block B₁ after receiving the data block B_{M}. Furthermore, the client 56B generates a receiving history regarding the data block first received. The client 56B stops receiving the data blocks after receiving the data block B_{N-1} based on the receiving history. By this strategy, the client 56B can completely download all data blocks of the data series.

According to the data transferring method of the present invention, when different clients request the same data from the server at different instances, the server does not have to create a corresponding multicast group for each client. All clients can join the same multicast group. By generating a receiving history regarding the data block first received, all clients can know when to stop receiving the data blocks and complete the data transfer. The data transferring method according to the present invention can dramatically reduce the loading on the server. The transferring efficiency increases as the number of the clients increases. The construction and maintenance cost of the network and the server can also be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A data transferring method for a multicast system, the multicast system including a server, a switch, and a plurality of clients, the data transferring method comprising the steps of:
creating a multicast group by the server;
casting a plurality of data blocks of a data series sequentially and repeatedly by the server;
joining the multicast group for receiving the data blocks forwarded by the switch when one of the clients wants to receive the data series at an instance;
receiving the data blocks of the data series from the data block that the server is casting at the instance and generating a receiving history of the data block that the server is broadcasting at the instance; and
determining when to stop receiving the data blocks based on the receiving history.

2. A data transferring method of claim 1, wherein the switch employs IGMP (Internet Group Management Protocol) for managing the multicast group.

3. A data transferring method of claim 1, wherein the data transferring method is employed in an assembly line of a computer manufacturing factory or a system requiring copying massive identical data.

4. A data transferring method of claim 3, wherein the clients are a plurality of computers.

5. A data transferring method of claim 3, wherein the data series is computer software.

6. A data transferring method of claim 5, wherein the data series is an operating system.

7. A multicast system for transferring data, the multicast system comprising:
a server for creating a multicast group and broadcasting a plurality of data blocks of a data series sequentially and repeatedly;
a plurality of clients; and
a switch for forwarding the data blocks to the clients joining the multicast group;
wherein when one of the clients wants to receive the data series at an instance, it joins the multicast group, receives the data blocks of the data series from the data block that the server is currently broadcasting at the instance, generates a receiving history of the data block that the server is currently broadcasting at the instance, and determines when to stop receiving the data blocks based on the receiving history.

8. A multicast system of claim 7, wherein the switch employs IGMP (Internet Group Management Protocol) for managing the multicast group.

9. A multicast system of claim 7, wherein the multicast system is employed in an assembly line of a computer manufacturing factory or a system requiring copying massive identical data.

10. A multicast system of claim 9, wherein the clients are a plurality of computers.

11. A multicast system of claim 9, wherein the data series is computer software.

12. A multicast system of claim 11, wherein the data series is an operating system.
